(19) United States
(12) Patent Application Publication
(10) Pub. No.: US 2013/0259985 A1
(43) Pub. Date: Oct. 3, 2013

(54) Methods for Providing a Thermally Stable Purple Color in Packaged Foods

(71) Applicants: Jacqueline K. CURTIS, Walnut Creek, CA (US); Kelly Anne DAVENPORT, Pleasant Hill, CA (US); Michelle Emily MOY, Walnut Creek, CA (US); Bernadette Revel-McInnis DAVIS, Pleasant Hill, CA (US)

(72) Inventors: Salvador GARCIA, Lakeland, FL (US); Jacqueline K. CURTIS, Walnut Creek, CA (US); Kelly Anne DAVENPORT, Pleasant Hill, CA (US); Michelle Emily MOY, Walnut Creek, CA (US); Bernadette Revel-McInnis DAVIS, Pleasant Hill, CA (US)

(21) Appl. No.: 13/438,152

(22) Filed: Apr. 3, 2012

(51) Int. Cl. A23L 1/275

(52) U.S. Cl. CPC A23L 1/2751
USPC 426/250

(57) ABSTRACT

Methods are provided for preparing a thermally stable purple color comprising at least one source of anthocyanins. The purple color is stable in adverse conditions such as light exposure, various pHs, and cold through to hot temperature exposure. The purple color is prepared from a combination of sufficient amounts of anthocyanin from at least one source; stabilized by formation of anthocyanin-tin complexes in a media comprising the anthocyanins; and supplemented by anthocyanin supplements.

### FIELD OF THE INVENTION

The invention generally relates to systems and methods for providing a thermally stable purple color useful in packaged foods.

### BACKGROUND OF THE INVENTION

The coloring of foodstuffs and condiments dates back at least 500 years. Colorants are added to food products to improve or maintain appearance. To consumers, off-colored food suggests inferior products. Some food producers believe that consumers view the color of a food product more favorably than its flavor. Colorants are added to food products and food product media to make them recognizable, to compensate for loss of color during processing, to attract consumers to them, and/or to maintain a consistent food color during storage of a food product for the duration of its shelf life.

One natural source of food coloring is anthocyanin found in plants, flowers, fruits, and vegetables, and their juices. The representative phenolic colorant anthocyanin is a subgroup of flavonoids that are water-soluble glycosides of anthocyanidins. Anthocyanins contain a C₆C₃C₆ backbone and cover a broad range of the color spectrum including blue, purple, violet, magenta, red, and orange. Anthocyanins differ in the number of hydroxyl and/or methoxy groups present and sugars such as glucose, galactose, arabinose, and xylose which are attached to the 3 position in the C ring. The color of anthocyanins comes from excitation of a molecule by light and the strength of color is determined by the relative electron mobility in the structures. Anthocyanins are a rich source of antioxidants and are favorably viewed as a natural food additive and colorant.

A wide spectrum of colors can be extracted from natural products such as plants, flowers, fruits, and vegetables. For example, Asen et al. (U.S. Pat. No. 4,172,902) teach that anthocyanin collected from “Heavenly Blue” Morning Glory provides a broad spectrum of colors at a pH value range of 2 to 8 and purplish-red colors—matching the colors of cherry, strawberry, raspberry, and grape—at a pH value in the range of 3 to 6. Asen acknowledges that anthocyanins are chemically unstable.

The acidity of natural color compositions influences the color displayed by the composition. For example, Rice (United States Patent Application Publication No. 20100255177) discloses that delphinidin—an anthocyanidin present in blueberries, purple carrots, and eggplant peels—is also present in blue and purple pansies. When pansy extract and stannous chloride (a form of tin) combine, a blue flavorant is stable at a pH value of 3 to 7. Additionally, Masahiko (JP2008-142061) teaches using anthocyanin pigment having a pH value of about 5 to 6.5 for manufacturing foodstuffs having a purple color. The anthocyanin pigment is obtained from purple carrots.

One reference indicates that the reaction of tin complexes with anthocyanin serves as a way to form strong colors. For example, Pyysalo et al. “The role of iron and tin in discoloration of berry and red beet juices.” Z. Lebensm. Unters-Forsch., 153 (4) (1973) noted the reaction of tin (II) complexes with anthocyanin-containing berry juices to produce a strong blue color without noting the pH range. The strong blue color is attributable to the tin complexes with cyaniding and delphinidin glycosides. Pyysalo attributes considerable discoloration and precipitation to the presence of tin (II) complexes with certain glycosides.

Another reference observed that color degradation of canned pears is due to the formation of a purple-pink insoluble tin-anthocyanin complex. Chandler, B. V. et al., “Pink discoloration in canned pears I, role of tin in pigment formation,” J. Sci. For Agric., Vol. 21 (1970). Chandler discloses that treatment with strong acids leads to loss of color and such color is not reconstituted with the addition of an alkali. Chandler suggests that the intensity of discoloration in canned pears increases with increasing tin content.

A further reference suggests alumina as an alternative to tin to form food coloring substances. Kohler (U.S. Pat. No. 6,881,430) discloses food coloring substances useful in the manufacture of food products. Kohler discloses the formation of a food coloring substance including an extract of purple carrot or red cabbage combined with alumina. The food coloring substance provides a blue color at a pH value of about 8 or lower.

Another reference teaches use of co-pigments to mitigate against color loss. Lenoble (U.S. Pat. No. 5,908,650) discloses the use of water-soluble plant extracts as potent anthocyanin co-pigments that protect against anthocyanin color loss. The co-pigments protect against color loss caused by light, heat, and/or pH value.

Several drawbacks exist with the disclosed processes for using natural colors to color food. Most of the natural pigments and synthetic colors used for coloring food are relatively unstable when exposed to heat. Heat can bring physical and chemical changes to the color of those products. Blue to purple colors that are stable at high temperatures and during product storage are difficult to maintain at low pH and are not readily available commercially. Factors necessary to preserve some products over an extended period of time such as two to three years, including pH alterations, the effect of light, temperature, and/or thermal processing, also result in color loss and discoloration.

The description of the prior art provided in this disclosure highlights the need for an improved process for creating a thermally stable purple color for packaged food products such that (1) the purple color is stable and remains stable after heat exposure, (2) the purple color is stable at low pH value ranges, and (3) the purple color remains stable for extended periods of time typical for processed food products having a long shelf life.

### BRIEF DESCRIPTION OF THE DRAWINGS

Additional aspects, features, and advantages of the invention, as to its operation, will be understood and will become more readily apparent when the invention is considered in light of the following description of illustrative embodiments made in conjunction with the accompanying drawings, wherein:

FIG. 1 shows a flow diagram of processes for providing a thermally stable purple color useful in packaging food, according to embodiments of the invention.

### DETAILED DESCRIPTION OF EMBODIMENTS OF THE INVENTION

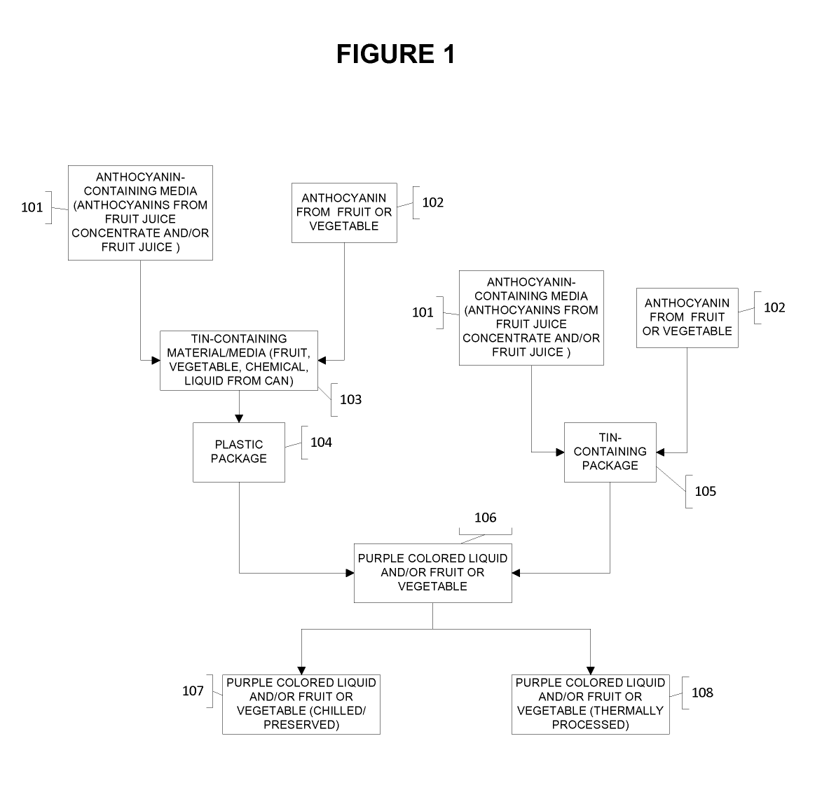

Illustrative and alternative embodiments of processes to produce a thermally stable purple color for food are discussed below in reference to FIG. 1 with variations of the processes noted in the disclosure of the invention. The invention provides processes to prepare acid stable and/or thermally stable purple colors comprising anthocyanin.

For the purposes of this application, the term “media” is used generally in reference to a solution that is used to pack fruits and/or vegetables (whole or pieces) in food containers. A non-limiting example of a media for fruit is a topping syrup. The media for the food product may comprise any one or combination of fruit juice(s), juice concentrate(s), natural color(s), natural flavor(s), acid(s), preservative(s), sweetener(s) or artificial sweetener(s), and/or texturizing agent(s) such as gums or starches.

The term “acid” is used generally in reference to any one or combination of organic acids and/or inorganic acids. Citric acid and ascorbic acid are non-limiting examples of acids that may be used with the invention.

Additionally, the phrases “thermally processed,” “thermal processing,” and the like, are used generally in reference to heating a sealed food container holding fruit or vegetable products and media to a commercially-acceptable center of container temperature. In this regard, the temperatures reach those typically used in commercial processing and packaging of fruits and vegetables. For example, the center of container may be heated to a temperature in a range from about 145° F. to about 280° F. This range accounts for thermal processing temperatures at atmospheric pressure and at positive pressures used for commercial thermal processing of food. In another example, the center of container may be heated to a temperature in a range from about 190° F. to about 220° F. for thermal processing of fruit packaged in plastic cups. As disclosed in this application, thermal processing is presented as a condition during and after which the purple color remains stable. Thermal processing is not a limitation of the invention.

The term “anthocyanin” is used generally in reference to water-soluble glycosides of anthocyanidins and contain a C₆C₃C₆ backbone. Anthocyanin can be sourced from plants, flowers, fruits, and vegetables 102. For example, the flesh of the fruit and/or vegetable can provide a source of anthocyanins. Flowers can be used as a source of anthocyanins. Anthocyanins can also be sourced from juices and juice concentrates of plants, flowers, fruits, and vegetables 101. For example, juice concentrate can originate from blueberries, blackberries, Acai berries, red cabbage, beets, etc. Juice can comprise water and juice concentrate obtained from blueberries, blackberries, Acai berries, etc. Yet another source is anthocyanin supplements in powder or liquid form. Anthocyanins supplements may be obtained from extracts of plants, flowers, fruits, and/or vegetables.

The phrases “food grade container,” “food container,” and the like, are used generally in reference to any type of sealable container for food including, but not limited to, metal cans, plastic bowls, cups or pouches, or any other device in which food may be sealed.

The phrase “color change,” “change in color,” and the like are used generally to refer to a reaction observed visually or determined qualitatively.

Thermally Stable Purple Color

A purpose of the invention is to provide a purple color 107, 108 that is stable in adverse conditions such as those arising from light exposure, various pH ranges, and cold through to hot temperatures. A further purpose of the invention is to provide a heat resistant purple color suitable for coloring acidified fruits and vegetables 108. Another purpose of the invention is to provide a preparation of a purple color that is stable across a broad range of temperatures, such as chilled temperatures through to temperatures reached in retort 107, 108. The invention also provides a preparation of purple color that is stable in storage with a food product 107, 108.

Referring now to FIG. 1, thermally stable purple color forms in media from any one or combination of the following: (1) anthocyanin in media 101 or fruit or vegetable 102, (2) anthocyanin-tin complexes formed from anthocyanin exposure to tin 103, 105 from (a) tin-lined containers, (b) tin additives mixed with media such as stannous chloride in solution, (c) remanufactured food such as fruits and/or vegetables (this refers generally to a food item packed in a tin-lined container), and (d) media previously exposed to tin and then reclaimed for use as a component of new media, and (3) anthocyanin supplements added to media.

Anthocyanin combines with tin to form tin-anthocyanin complexes. These complexes provide and stabilize the purple color provided by fruit or vegetables, their juices or juice concentrates, or color additives 103, 105. In an embodiment, thermally stable purple color can result from the combination of anthocyanin(s) such as from fruit juice, fruit juice concentrates, or other anthocyanin sources with tin 106, 107, 108. In alternative embodiments, the purple color may also be stabilized with anthocyanin supplements used to create a high concentration of anthocyanins in media. According to the invention, the thermally stable purple color forms at a pH value in a range of about 2 pH to about 6 pH, in a range of about 2 pH to about 4 pH, and in a range of about 3.5 pH to about 4 pH. Within the range of about 3.5 pH to about 4 pH, anthocyanin characteristically exhibits red color, not purple color.

In an illustrative embodiment of the invention, a source of anthocyanin(s) 102 such as, for example, from concentrate (fruit and/or vegetable) and/or single strength juice (fruit and/or vegetable), is added to media used to immerse a food product 101, 102 in a food container 104, 105. For example, the juice concentrate may originate from one or combination of blueberries, blackberries, Acai berries, red cabbage, beets, etc. The juice may comprise water and any one or combination of the juice concentrate. In an alternative embodiment, the source of anthocyanin(s) originates from a fruit or vegetable itself 102. In this embodiment, media and anthocyanin-containing fruit or vegetable is combined in a food grade container.

In a study, individually quick frozen (IQF) blueberries (Duke variety) were combined with remanufactured diced pears and a topping syrup in a 4 ounce plastic cup. The combination was created according to the percentages of ingredients listed on Table 1. The topping syrup consisted of water, sugar, citric acid, ascorbic acid, and blueberry flavor at the percentages according to Table 1. For clarity, the percentages of the topping syrup components equal the total percentage of the topping syrup (i.e., 45%) in the finished packaged product. The topping syrup in the cup changed to a purple color before the cup and its contents were thermally processed. For those cups that were thermally processed, the purple color remained after the cup was exposed to heat.

TABLE 1
Purple Color Reaction with Blueberries and
Remanufactured Pears in Topping Syrup

| Ingredients | % (by weight or volume) |
|---|---|
| Reman Pears (#10 can) | 41.7 |
| IQF Blueberries (Duke variety) | 13.3 |
| Topping Syrup | 45 |
| Water | 32.92335 |
| Sugar | 11.73780 |
| Citric Acid | 0.10125 |
| Ascorbic Acid | 0.10260 |
| Blueberry Flavor | 0.13500 |

At a pH value of about 3.5 to about 4, the topping syrup changes to a purple colored liquid without heat processing after time. For example, the color change occurred after about 0.166 to about 0.25 hours 106, 107. After combining the fruit and topping syrup, the container can then be stored refrigerated 107 or be thermally processed 108 at which conditions the purple color remains stable.

While the study presents specific percentages (by weight or volume) of ingredients, additional embodiments of the invention may comprise ingredients in the following ranges (also by weight or volume): remanufactured pears (#10 can) at about 45 to about 50%, IQF Blueberries (Duke variety) at about 10 to about 15%, and topping syrup at about 40 to about 50%. In embodiments of the topping syrup, the ingredients may comprise water at about 30 to about 35%, sugar at about 10 to about 15%, acids (such as citric and/or ascorbic) at about 0 to about 1%, and flavor (such as Blueberry flavor) at about 0 to about 1%. The ingredient percentages must be adjusted accordingly to equate to 100% in any embodiment of the invention.

Thermally Stable Purple Color: Purple Color Reaction with Tin-Anthocyanin Complexes and Anthocyanin Supplements

In another illustrative embodiment of the invention illustrated generally in FIG. 1, a source of anthocyanins 101 such as, for example, from fruit juice concentrate and/or fruit juice is added to media 102 used to immerse a food product. As previously described, the source of anthocyanin(s) can also be a fruit or vegetable itself 102. The media or anthocyanin-containing fruit or vegetable is then combined in a food grade container with a tin-containing compound or lining 105, remanufactured fruit(s), remanufactured vegetable(s), tin in the form of stannous chloride 103, or reclaimed liquid 103 in which remanufactured fruit(s)/vegetable(s) was previously immersed. The media at a pH value of about 3.5 to about 4 will change to a purple colored liquid without thermal processing over time. For example, this color change may occur after about 0.166 to about 0.25 hours 105. After fruit and media are combined in a container, the container may be hermetically sealed. The sealed container may then be stored refrigerated 107 if the media contains preservatives, or be thermally processed 108, which, under either condition, the purple color remains stable.

In a further illustrative embodiment of the invention, the media or anthocyanin-containing fruit or vegetable is combined in a food grade container (with or without tin-lining or tin additive) with an anthocyanin supplement. The media at a pH value of about 3.5 to about 4.0 will change to a purple colored liquid without heat processing over time, for example, about 0.166 to about 0.25 hours 105. After fruit and media are combined in a container, the container may be hermetically sealed. The sealed container may then be stored refrigerated 107 or undergo thermal processing 108 which, in either condition, the purple color remains stable.

Tin-Anthocyanin Complexes Create Purple Color With Deeper Hue as Compared to Purple Color from Food Dyes

In a study, various media comprising food colorings, such as FD&C Red No. 40, carmine, blue carmine, purple carmine, and FD&C Blue No. 1, were compared with media comprising tin-anthocyanin complexes. The depth of purple hue resulting from the various medias combined with remanufactured pears removed from #10 cans was determined. The following mixtures were created: IQF blueberries (Duke variety) were combined with thermally processed pears with various media (A-G) containing sugar, acids, flavor, and colors (Blue No. 1, Red No. 40, Carmine, Red 40000 (grape skin extract), or GNT Exberry Shade Bordeaux) according to the ingredients and concentrations in Table 2. Blueberries, pears, and media were combined in 4 ounce plastic cups and was then thermally processed.

TABLE 2
Ingredients for Comparative Study of Food Dyes

| | Study Variables: % by weight or volume | | | | | | |
|---|---|---|---|---|---|---|---|
| Ingredients | A | B | C | D | E | F | G |
| Reman | 47.00 | 47.00 | 47.00 | 47.00 | 47.00 | 47.00 | 47.00 |
| Pears (#10 can) | | | | | | | |
| IQF | 8.00 | 8.00 | 8.00 | 8.00 | 8.00 | 8.00 | 8.00 |
| Blueberries | | | | | | | |
| (Duke) | | | | | | | |
| Topping | 45.00 | 45.00 | 45.00 | 45.00 | 45.00 | 45.00 | 45.00 |
| Syrup | | | | | | | |
| Water | 35.3613 | 35.2869 | 35.3294 | 35.3826 | 35.3471 | 35.3223 | 35.3401 |
| Sugar | 9.2061 | 9.1867 | 9.1978 | 9.2116 | 9.2024 | 9.1959 | 9.2005 |
| Citric Acid | 0.1010 | 0.1008 | 0.1009 | 0.1011 | 0.1010 | 0.1009 | 0.1010 |
| Ascorbic Acid | 0.1024 | 0.1022 | 0.1023 | 0.1024 | 0.1023 | 0.1023 | 0.1023 |
| Blueberry | 0.1347 | 0.1344 | 0.1346 | 0.1348 | 0.1347 | 0.1346 | 0.1346 |
| Flavor | | | | | | | |
| Blue 1 | 0.0675 | 0.135 | 0.135 | 0.0225 | 0.045 | 0.009 | 0.009 |
| (1% solution) | | | | | | | |
| Red 40 | 0.027 | 0.054 | 0 | 0 | 0 | 0 | 0 |
| (10% Solution) | | | | | | | |
| Carmine | 0 | 0 | 0 | 0.045 | 0.0675 | 0 | 0 |
| Shade | 0 | 0 | 0 | 0 | 0 | 0.135 | 0 |
| Bordeaux | | | | | | | |
| Red 40000 | 0 | 0 | 0 | 0 | 0 | 0 | 0.1125 |

The results of the study showed that media dyed with food colorings does not result in the same visual depth of purple color as compared to media having tin-anthocyanin complexes of other studies.

While the study used specific percentages (by weight or volume) of ingredients, embodiments of the ingredients may comprise the following (also by weight or volume): remanufactured pears (#10 can) at about 45 to about 50%, IQF Blueberries (Duke variety) at about 5 to about 1%, and topping syrup at about 40 to about 50%. Topping syrup ingredients may comprise water at about 30 to about 35%, sugar at about 10 to about 12%, acid (citric and/or ascorbic) at about 0 to about 1%, flavor (such as Blueberry flavor) at about 0 to about 1%, and color additives (for example any one or combination of Blue 1 (1% solution), Red 40 (10% solution), Carmine, Shade Bordeaux, Red 40000) at about 0 to about 1%. The ingredient percentages must be adjusted accordingly to equate to 100% in any embodiment of the invention. Without limiting any aspect of the invention, adjustments to the ingredient percentages may be made according to this disclosure to reach a desired purple color hue.

Remanufactured Pears as Source of Tin

Tin present in remanufactured fruit and/or vegetables can produce the purple color reaction. Tin from the tin-lined steel cans absorbs into the flesh of the fruit or vegetable. In a study, remanufactured pears were combined with various mixtures of media according to Table 3. Each media had mixtures of white grape juice concentrate, pear juice concentrate, Acai juice, Marion blackberry concentrate, and the combination of Acai juice and Marion blackberry concentrate, and acids (citric and/or ascorbic) to determine if juice components contributed to the purple color reaction.

TABLE 3
Purple Color Reaction with Remanufactured Fruit

| | Variables: % by weight or volume | | | | |
|---|---|---|---|---|---|
| Ingredients | A | B | C | D | E |
| Reman Pears (#10 | 60 | 60 | 60 | 60 | 60 |
| can) | | | | | |
| Topping Syrup | 40 | 40 | 40 | 40 | 40 |
| Water | 30.668 | 39.468 | 38.808 | 39.66 | 38.66 |
| White Grape Juice | 9.140 | 0 | 0 | 0 | 0 |
| Concentrate | | | | | |
| Pear Juice | 0 | 0.340 | 0 | 0 | 0 |
| Concentrate | | | | | |
| Acai Clarified Juice | 0 | 0 | 1.0 | 0 | 1.0 |
| Marion Blackberry | 0 | 0 | 0 | 0.148 | 0.148 |
| Concentrate | | | | | |
| Ascorbic Acid | 0.092 | 0.092 | 0.092 | 0.092 | 0.092 |
| Citric Acid | 0.100 | 0.100 | 0.100 | 0.100 | 0.100 |

Neither pears packed in white grape juice, nor pear juice, changed color to purple. Pears packed in Acai juice had a slight purple color change and pears packed in Marion blackberry concentrate had a purple color change. Pears packed in the combination of Acai and Marion blackberry had a purple color change as well.

While the study presents specific percentages (by weight or volume) of ingredients, additional embodiments of the invention may comprise ingredients at the following ranges (also by weight or volume): remanufactured pears (#10 can) at about 55 to about 65% and topping syrup at about 35 to about 45%. Various embodiments of topping syrup may be used. In these various embodiments, topping syrup ingredients may comprise water at about 30 to about 35%, acids (citric and/or ascorbic) at about 0 to about 1%, juice(s) at about 0 to about 2%, and juice concentrate(s) at about 0 to about 10%. More specifically, topping syrup may comprise water at about 30 to about 35%, juice concentrate (white grape) at about 5 to about 10%, and acids (citric and/or ascorbic) at about 0 to 1%. Topping syrup may comprise water at about 30 to about 35%, juice concentrate (pear) at about 0 to about 1%, and acid (citric and/or ascorbic) at about 0 to about 1%. Topping syrup may comprise water at about 30 to about 35%, juice (Acai clarified) at about 0 to about 2%, and acids (citric and/or ascorbic) at about 0 to about 1%. Topping syrup may comprise water at about 30 to about 40%, juice concentrate (Marion blackberry) at about 0 to about 1%, and acids (citric and/or ascorbic) at about 0 to about 1%. Topping syrup may comprise water at about 30 to about 40%, juice (Acai clarified) at about 0 to about 2%, juice concentrate (Marion blackberry) at about 0 to about 1%, and acids (citric and/or ascorbic) at about 0 to about 1%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

Tin Present in Tin Exposed Media Stabilizes Purple Color

In another study, remanufactured pears in #10 cans and in glass jars were drained of their media. The drained media was reclaimed and kept separated as originating from cans and from glass jars. The drained media was reclaimed for use in various percentages (by weight or volume) in the topping syrup for blueberry and pear cups according to the variables A-E of Table 4.

TABLE 4
Reclaimed Media Incorporated into Topping Syrup

| | Variables: % by weight or volume | | | | |
|---|---|---|---|---|---|
| Ingredients | A | B | C | D | E |
| Reman Pears (#10 can) | 47.00 | 42.30 | 37.60 | 30.50 | 23.50 |
| Reman Pears (glass) | 0 | 4.70 | 9.40 | 16.50 | 23.50 |
| IQF Blueberries (Duke variety) | 8.00 | 8.00 | 8.00 | 8.00 | 8.00 |
| Topping Syrup | 45.00 | 45.00 | 45.00 | 45.00 | 45.00 |
| Water | 0.00 | 29.35350 | 26.27955 | 21.66435 | 17.05680 |
| Reclaim liquid from Reman | 32.4279 | 3.375 | 6.75 | 11.8125 | 16.875 |
| pears (#10 can) | | | | | |
| Sugar | 12.23325 | 11.93265 | 11.63160 | 11.18430 | 10.72935 |
| Citric Acid | 0.10125 | 0.10125 | 0.10125 | 0.10125 | 0.10125 |
| Ascorbic Acid | 0.10260 | 0.10260 | 0.10260 | 0.10260 | 0.10260 |
| Blueberry Flavor | 0.13500 | 0.13500 | 0.13500 | 0.13500 | 0.13500 |

All samples turned purple with slight cup to cup variation.

While the study presents specific percentages (by weight or volume) of ingredients, additional embodiments of the invention may comprise ingredients at the following ranges (also by weight or volume): remanufactured pears (#10 can and glass) at about 45 to about 50%, IQF blueberries (Duke variety) at about 5 to about 10%, and topping syrup at about 40 to about 50%. Various embodiments of topping syrup may be used. In these various embodiments, topping syrup ingredients may comprise a combination of water and reclaimed media at about 25 to about 35%, sugar at about 10 to about 15%, acid (citric and/or ascorbic) at about 0 to about 1%, juice(s) at about 0 to about 2%, and flavor (such as blueberry) at about 0 to about 1%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

In a comparative study, a syrup was prepared according to the ingredients of Table 5 and was then thermally processed in tin-coated steel cans. After thermal processing, the syrup was added as a component of a topping syrup for IQF blueberries and remanufactured pears (Orchard Select), which had been thermally processed in glass jars. Various compositions of topping syrup were packed with the blueberries and pears according to the percentages of Table 6.

TABLE 5
Syrup Prepared to be Thermally Processed

| Syrup | % by weight or volume |
|---|---|
| Water | 91.1106 |
| Sugar | 8.8504 |
| Citric Acid | 0.039 |

In different embodiments, syrup ingredients may be prepared for thermal processing in tin-coated steel cans as follows: water at about 90 to about 95%, sugar at about 5 to about 10%, and acid (citric and/or ascorbic) at about 0 to about 1%. Without limiting any aspect of the invention, adjustments to the ingredient percentages may be made according to this disclosure to reach a desired topping syrup.

TABLE 6
Comparative Study of Topping Syrups comprising Previously
Thermally Processed Syrup in Tin Cans

| | Variables: % by weight or volume | | | |
|---|---|---|---|---|
| Ingredients | A | B | C | D |
| Reman Pears | 47 | 47 | 47 | 47 |
| (glass) | | | | |
| IQF Blueberries | 8 | 8 | 8 | 8 |
| (Duke variety) | | | | |
| Topping Syrup | 45 | 45 | 45 | 45 |
| Syrup from Table 5 | 38.76255 | 25.65 | 12.87 | 0 |
| Water | 0 | 11.9322 | 23.562 | 35.2737 |
| Sugar | 5.89860 | 7.07895 | 8.22915 | 9.38745 |
| Citric Acid | 0.10125 | 0.10125 | 0.10125 | 0.10125 |
| Ascorbic Acid | 0.10260 | 0.10260 | 0.10260 | 0.10260 |
| Blueberry Flavor | 0.135 | 0.135 | 0.135 | 0.135 |

The samples made with the drained media changed to a purple color.

While the study presents specific percentages (by weight or volume) of ingredients, additional embodiments of the invention may comprise ingredients at the following ranges (also by weight or volume): remanufactured pears (from glass) at about 45 to about 50%, IQF blueberries (Duke variety) at about 5 to about 10%, and topping syrup at about 40 to about 50%. Various embodiments of topping syrup may be used. In these various embodiments, topping syrup ingredients may comprise a combined mixture of water and thermally processed topping syrup (from Table 5) at about 35 to about 40%, sugar at about 5 to about 10%, acid (citric and/or ascorbic) at about 0 to about 1%, and flavor (blueberry) at about 0 to about 1%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

Remanufactured Fruit With Tin Content Promotes Purple Color Reaction

A purple color reaction occurs when remanufactured fruit, such as pears, with absorbed tin content are soaked in topping syrups with juice concentrates. This reaction does not occur with fresh fruits, which do not contain tin. In a study, remanufactured pears were compared against fresh pears (Tayler and Comice varieties) purchased from a grocery store. The appearance of the Taylor and Comice pears appeared similar so they were combined to represent the fresh pear variables. Fresh pears were also soaked in the syrup from the remanufactured pear can for 20 minutes (Variable C in Table 7) prior to packing with the topping syrup. The remanufactured pears had a starting tin content of 98 ppm compared to fresh pears, which contained <1 ppm tin. White grape juice concentrate, pear juice concentrate, Acai clarified juice, and water were combined according to Table 7 and used as the topping syrup.

TABLE 7
Comparative Study of Purple Color Reaction
with Fresh and Remanufactured Fruit

| | Variables: % by weight or volume | | |
|---|---|---|---|
| Ingredients | A | B | C |
| Reman Pears (#10 can) | 60 | 0 | 0 |
| Fresh Pears (Taylor, Comice) | 0 | 60 | 0 |
| Fresh Pears soaked in Reman Syrup | 0 | 0 | 60 |
| (Taylor, Comice) | | | |
| Topping Syrup | 40 | 40 | 40 |
| Water | 28.556 | 28.556 | 28.556 |
| White Grape Juice Concentrate | 9.764 | 9.764 | 9.764 |
| Pear Juice Concentrate | 0.34 | 0.34 | 0.34 |
| Acai Clarified Juice | 1.0 | 1.0 | 1.0 |
| Marion Blackberry Concentrate | 0.148 | 0.148 | 0.148 |
| Ascorbic Acid | 0.092 | 0.092 | 0.092 |
| Citric Acid | 0.1 | 0.1 | 0.1 |

Remanufactured pears, which have tin at about 98 ppm, were placed in 8 ounce cups, combined with the topping syrup, and observed with and without thermal processing. In the finished product, the tin content in the cup (variable A on Table 7) was 58 ppm tin. The purple color reaction occurred with the remanufactured pears with and without thermal processing.

Fresh pears, which contained 1 ppm tin or less, were soaked in reclaimed syrup containing about 60 ppm tin for about 20 minutes. The fresh, soaked pears were then combined with the topping syrup (white grape juice concentrate, pear juice concentrate, and Acai clarified juice) in an 8 ounce cup. The pears had a slight purple color change prior to thermal processing and had some purple notes after thermal processing. The finished product contained about 4 ppm tin.

The fresh pears in topping syrup had no color change and <1 ppm of tin in the finished product.

As a control, a topping syrup comprising white grape concentrate, Acai clarified juice, and pear juice concentrate was placed into a tin-coated, steel can, and the can was stored at refrigerated temperatures overnight. It produced no visually perceived color change.

While the study presents specific percentages (by weight or volume) of ingredients, additional embodiments of the invention may comprise ingredients at the following ranges (also by weight or volume): remanufactured pears (#10 can) at about 55 to about 65% and topping syrup at about 35 to about 45%. In alternative embodiments, the invention comprises the following: fresh pears (Taylor, Comice) at about 55 to about 65% and topping syrup at about 35 to about 45%. In further embodiments, the invention comprises the following: fresh pears (Taylor, Comice) soaked in remanufactured media at about 55 to about 65% and topping syrup at about 35 to about 45%. Various embodiments of topping syrup may be used. In these various embodiments, topping syrup ingredients may comprise water at about 25 to about 30%, juice concentrate (white grape) at about 5 to about 10%, juice concentrate (pear) at about 0 to about 1%, juice concentrate (Marion blueberry) at about 0 to about 2%, juice (Acai clarified) at about 0 to about 2%, and acids (Ascorbic and/or citric) at about 1 to about 2%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

Purple Color Reaction with Pears Stored in Tin-Lined Containers

In another study, remanufactured pears were removed from their storage from glass containers and from tin-lined cans. The remanufactured pears were kept in two lots—one lot from glass jars and the other lot from cans. The lots were kept separate throughout the study (e.g., glass and can), and the separate lots were packed with topping syrup in food containers. The study sought to determine if the purple color reaction occurred in samples packed in a topping syrup. The topping syrup, which contained water, sugar, acids, and flavor, was packed in 4 ounce cups with either remanufactured pears from tin-lined cans or from glass containers (as shown on Table 8) and was thermally processed. The color change was visually determined.

TABLE 8
Comparing Purple Color Reaction between Remanufactured
Pears from Tin-Lined Cans and Glass Containers

| | Variables: % by weight or volume | | |
|---|---|---|---|
| Ingredients | A | B | C |
| Reman Pears (#10 can) | 47 | 0 | 41.7 |
| Reman Pears (glass) | 0 | 47 | 0 |
| IQF Blueberries (Duke variety) | 8 | 8 | 13.3 |
| Topping Syrup | 45 | 45 | 45 |
| Water | 33.09660 | 35.44650 | 33.27120 |
| Sugar | 11.56455 | 9.21465 | 11.38995 |
| Citric Acid | 0.10125 | 0.10125 | 0.10125 |
| Ascorbic Acid | 0.10260 | 0.10260 | 0.10260 |
| Blueberry flavor | 0.13500 | 0.13500 | 0.13500 |

The cups made with remanufactured pears from a tin coated steel can had a purple color reaction, but the cups made with Orchard Select pears had no color reaction.

While the study presents specific percentages (by volume or weight) of ingredients, additional embodiments of the invention may comprise ingredients at the following ranges (also by volume or weight): remanufactured pears (#10 can) and/or remanufactured pears (glass) at about 55 to about 65%, IQF blueberries (Duke variety) at about 5 to about 10%, and topping syrup at about 40 to about 50%. Various embodiments of topping syrup may be used. In these various embodiments, topping syrup ingredients may comprise water at about 30 to about 35%, sugar at about 8 to about 13%, acids (citric and/or ascorbic) at about 0 to about 1%, and flavor (blueberry) at about 0 to about 1%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

Purple Color Reaction Results when Tin is an Additive

As previously disclosed in this application, tin can be mixed with media as an additive. In a study, the purple color change occurred when tin (i.e., 5% stannous chloride solution), which was used as a component of the topping syrup, was combined in different concentrations with anthocyanin provided by the blueberries packed in a cup. The ingredients were tested in various combinations as described in Table 9. The change in color was visually observed.

TABLE 9
Purple Color Reaction from Tin added to Cup of Blueberries

| | Variables | | | | |
|---|---|---|---|---|---|
| Ingredients | A | B | C | D | E |
| Reman Pears (glass) | 47 | 47 | 47 | 47 | 47 |
| IQF Blueberries (Duke variety) | 8 | 8 | 8 | 8 | 8 |
| Topping Syrup | 45 | 45 | 45 | 45 | 45 |
| Water | 36.52920 | 36.49852 | 36.48318 | 36.37614 | 36.22272 |
| Sugar | 8.13195 | 8.12512 | 8.12170 | 8.09788 | 8.06372 |
| Citric Acid | 0.10125 | 0.10116 | 0.10112 | 0.10083 | 0.10040 |
| Ascorbic Acid | 0.10260 | 0.10251 | 0.10247 | 0.10217 | 0.10174 |
| Blueberry Flavor | 0.13500 | 0.13489 | 0.13483 | 0.13443 | 0.13387 |
| Stannous Chloride 5% Solution | 0 | 0.0378 | 0.05670 | 0.18855 | 0.37755 |
| Stannous Chloride | 0 | 0.00189 | 0.00284 | 0.00943 | 0.01888 |
| Water | 0 | 0.03591 | 0.05387 | 0.17912 | 0.35867 |

The combination of stannous chloride with anthocyanin from blueberries resulted in a purple color change after thermal processing.

While the study presents specific percentages (by weight or volume) of ingredients, additional embodiments of the invention may comprise ingredients at the following ranges (also by weight or volume): remanufactured pears (glass) at about 45 to about 50%, IQF blueberries (Duke variety) at about 5 to about 10%, and topping syrup at about 40 to about 50%. Various embodiments of topping syrup may be used. In these various embodiments, topping syrup ingredients may comprise water at about 35 to about 40%, sugar at about 5 to about 10%, acid (citric and/or ascorbic) at about 0 to about 1%, and flavor (blueberry) at about 0 to about 1%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

Tin from Can

Tin can also originate from the tin lining of a steel can. In a study, fresh pears (a combination of Taylor and Comice varieties) were combined in a tin-lined steel can according to the ingredients of Table 10. The can without a lid was placed in a pot of boiling water and color change was visually monitored over time as shown on Table 11.

TABLE 10
Purple Color Reaction by Heating Tin-lined Steel Can

| Ingredients | % by weight or volume |
|---|---|
| Fresh Pears (Taylor, Comice) | 60 |
| Topping Syrup | 40 |
| Water | 29.848 |
| White Grape Juice Concentrate | 8.472 |
| Pear Juice Concentrate | 0.34 |
| Acai Clarified Juice | 1 |
| Marion Blackberry Concentrate | 0.148 |
| Ascorbic Acid | 0.092 |
| Citric Acid | 0.1 |

TABLE 11
Observations of Color Change Over Time

| Elapsed Time (minutes) | Color Observation |
|---|---|
| 8 | Light red |
| 15 | Light red |
| 25 | Dirty red |
| 45 | Red/purple hue on pears |
| 55 | Stronger purple hue on pears |

After about 45 minutes, a purple color formed and increased in hue after about 55 minutes.

While the study presents specific percentages (by weight or volume) of ingredients, additional embodiments of the invention may comprise ingredients at the following ranges (also by weight or volume): fresh pears (Taylor, Comice) at about 55 to about 65%, and topping syrup at about 35 to about 45%. Various embodiments of topping syrup may be used. In these various embodiments, topping syrup ingredients may comprise water at about 25 to about 30%, juice concentrate (white grape) at about 5 to about 10%, juice concentrate (pear) at about 0 to about 1%, juice (Acai clarified) at about 0 to about 2%, juice concentrate (Marion blackberry) at about 0 to about 1%, and acid (citric and/or ascorbic) at about 0 to about 1%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

Purple Color Reaction from Tin-Lined Food Container

In a study, remanufactured pears and Acai and blackberry juice media were packed in several cans with cut pieces of tin-coated steel can (as shown on Table 12) and thermally processed. The color change was visually analyzed.

TABLE 12
Purple Color Reaction from Tin of Food Container

| Ingredients | % by weight or volume |
|---|---|
| Reman Pears (#10 can) | 60 |
| Topping Syrup | 40 |
| Water | 28.492 |
| White Grape Juice Concentrate | 9.764 |
| Pear Juice Concentrate | 0.34 |
| Acai Clarified Juice | 1 |
| Marion Blackberry Concentrate | 0.148 |
| Ascorbic Acid | 0.092 |
| Citric Acid | 0.1 |
| Flavor | 0.064 |

One can resulted in no color reaction, two had a slight purple color reaction, and three had a definite purple color reaction.

While the study presents specific percentages (by volume or weight) of ingredients, additional embodiments of the invention may comprise ingredients at the following ranges (also by volume or weight): remanufactured pears (#10 can) at about 55 to about 65%, and topping syrup at about 35 to about 45%. Various embodiments of topping syrup may be used. In these various embodiments, topping syrup ingredients may comprise water at about 25 to about 30%, juice concentrate (white grape) at about 5 to about 10%, juice concentrate (pear) at about 0 to about 1%, juice (Acai clarified) at about 0 to about 2%, juice concentrate (Marion blackberry) at about 0 to about 1%, acid (citric and/or ascorbic) at about 0 to about 1%, and flavor (blueberry) at about 0 to about 1%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

Anthocyanin Supplements Support Thermal Stability of Purple Color

At high concentrations, anthocyanin stabilizes itself in solution, and the purple color is thermally stable in the presence of high levels of anthocyanin. For example, high levels of anthocyanins are generally bound at about 10 ppm to about 50 ppm in solution. In an embodiment, the anthocyanins are at about 25 ppm in solution.

Anthocyanin Supplements Stabilize Purple Color

A study was performed to determine the color stability of EXBERRY Shade “Red” (Product No. 153330) and EXBERRY Shade “Bordeaux” (Product No. 181524) in Del Monte Foods “Superfruit, Pear Chunks in a blend of juices including Acai & Blackberry” after simulated exposure to normal retail environments. EXBERRY® coloring foodstuffs are made from edible fruits, vegetables, and plants. The colors are manufactured through physical processes without selective extraction of pigments, and the colors retain the characteristics of the source material. The fruit and vegetable concentrates are classed as food ingredients, delivering healthy, clean-label color for food products.

Cups containing thermally-processed remanufactured pears in a topping syrup are described on Table 13. The topping syrup comprised a mixture of white grape juice concentrate (9.14% by weight or volume), pear juice concentrate (0.34% by weight or volume), Acai juice (1.0% by weight or volume) and Marion blackberry juice (0.148% by weight or volume) were stored in tin-lined steel cans with the addition of GNT Shade “Bordeaux,” which are fruit and vegetable based colors containing anthocyanin, were tested in storage for color stability. The levels of GNT's Shade “Bordeaux” ranged from 0.06-0.08% apart from the anthocyanins contributed by the Acai Juice and Marion Blackberry Juice.

TABLE 13
Anthocyanin Supplements and Purple Color Reaction

Variables: % by weight or volume

| Ingredients | A | B |
|---|---|---|
| Reman Pears (#10 can) | 60 | 60 |
| Topping Syrup | 40 | 40 |
| Water | 28.432 | 28.412 |
| White Grape Juice | 9.764 | 9.764 |
| Concentrate | | |
| Pear Juice Concentrate | 0.34 | 0.34 |
| Acai Clarified Juice | 1 | 1 |
| Marion Blackberry | 0.148 | 0.148 |
| Concentrate | | |
| Ascorbic Acid | 0.092 | 0.092 |
| Citric Acid | 0.1 | 0.1 |
| Flavor | 0.064 | 0.064 |
| Shade Bordeaux | 0.06 | 0.08 |

Using a Powers Scientific Photostability Chamber (PST54SD) to create accelerated storage conditions equivalent to 1, 3, 9, 10, 11, 12, 13, 14, and 15 months compared to a control that was stored refrigerated without light exposure, the color of the contents of the cups had a slight color change after 9 months and was acceptable at the end of 15 months. The Powers Scientific Photostability Chamber was used for qualitative evaluation of the color stability in food products by accelerating the conditions of light exposure (with an average light intensity of 9000 lux+/−10%) and heat (held at a constant elevated temperature of 40° C.+/−1° C.). This permitted approximation of the shelf life normally found under retail conditions in a shorter time period. Accelerated testing procedures give a reliable approximation to a target shelf life in real time based upon the light and heat exposure a food product may experience on the shelf, giving developers useful information about the expected color stability of a given formulation as shown on Tables 14 and 15.

While the study presents specific percentages (by weight or volume) of ingredients, additional embodiments of the invention may comprise ingredients at the following ranges (also by weight or volume): remanufactured pears (#10 can) at about 55 to about 65%, and topping syrup at about 35 to about 45%. Various embodiments of topping syrup may be used. In these various embodiments, topping syrup ingredients may comprise water at about 25 to about 30%, juice concentrate (white grape) at about 5 to about 10%, juice concentrate (pear) at about 0 to about 1%, juice (Acai clarified) at about 0 to about 2%, juice concentrate (Marion blackberry) at about 0 to about 1%, acid (citric and/or ascorbic) at about 0 to about 1%, flavor (blackberry) at about 0 to about 1% or alternatively 0.05 to about 0.1%, and coloring (shade Bordeaux) at about 0.05 to about 0.1%. The ingredient percentages for the product and the various toppings must be adjusted to equate to 100% in any embodiment of the invention. Without limiting any aspect of the invention, adjustments to the ingredient percentages may be made according to this disclosure to reach a desired purple color hue.

Similarly, further studies were performed by combining anthocyanin supplements with other natural colors.

TABLE 14
Anthocyanin Supplement Set (1223-47-A)

| Sample | Packaging | EXBERRY ® | Color Stability |
|---|---|---|---|
| Control | Opaque PET Cup with Clear Plastic | Shade “Red” + | N/A |
| | Lid | Shade “Bordeaux” | |
| 1 Month | Opaque PET Cup with Clear Plastic | Shade “Red” + | No perceived color change. |
| | Lid | Shade “Bordeaux” | |
| 3 Months | Opaque PET Cup with Clear Plastic | Shade “Red” + | No perceived color change. |
| | Lid | Shade “Bordeaux | |
| 9 Months | Opaque PET Cup with Clear Plastic | Shade “Red” + | Slight color loss in syrup |
| | Lid | Shade “Bordeaux | with some browning of |
| | | | syrup and fruit pieces. |
| | | | Color still acceptable. |
| 10 Months | Opaque PET Cup with Clear Plastic | Shade “Red” + | Slight color loss in syrup |
| | Lid | Shade “Bordeaux | and in fruit pieces with |
| | | | some browning of syrup |
| | | | and fruit pieces. Color still |
| | | | acceptable. |
| 11 Months | Opaque PET Cup with Clear Plastic | Shade “Red” + | Slight color loss in syrup |
| | Lid | Shade “Bordeaux” | and in fruit pieces with |
| | | | some browning of syrup |
| | | | and fruit pieces. Color still |
| | | | acceptable. |
| 12 Months | Opaque PET Cup with Clear Plastic | Shade “Red” + | Slight color loss in syrup |
| | Lid | Shade “Bordeaux” | and in fruit pieces with |
| | | | some browning of syrup |
| | | | and fruit pieces. Color still |
| | | | acceptable. |
| 13 Months | Opaque PET Cup with Clear Plastic | Shade “Red” + | Slight color loss in syrup |
| | Lid | Shade “Bordeaux | and in fruit pieces with |
| | | | some browning of syrup |
| | | | and fruit pieces. Color still |
| | | | acceptable. |
| 14 Months | Opaque PET Cup with Clear Plastic | Shade “Red” + | Slight color loss in syrup |
| | Lid | Shade “Bordeaux | and in fruit pieces with |
| | | | some browning of syrup |
| | | | and fruit pieces. Color still |
| | | | acceptable. |
| 15 Months | Opaque PET Cup with Clear Plastic | Shade “Red” + | Slight color loss in syrup |
| | Lid | Shade “Bordeaux | and in fruit pieces with |
| | | | some browning of syrup |
| | | | and fruit pieces. Color still |
| | | | acceptable. |

TABLE 15
Anthocyanin Supplement Set (1223-47-B)

| Sample | Packaging | EXBERRY ® | Color Stability |
|---|---|---|---|
| Control | Opaque PET Cup with Clear Plastic | Shade “Red” + | N/A |
| | Lid | Shade “Bordeaux” | |
| 1 Month | Opaque PET Cup with Clear Plastic | Shade “Red” + | No perceived color change. |
| | Lid | Shade “Bordeaux” | |
| 3 Months | Opaque PET Cup with Clear Plastic | Shade “Red” + | No perceived color change. |
| | Lid | Shade “Bordeaux | |
| 9 Months | Opaque PET Cup with Clear Plastic | Shade “Red” + | Slight color loss in syrup |
| | Lid | Shade “Bordeaux | with some browning of |
| | | | syrup and fruit pieces. |
| | | | Color still acceptable. |
| 10 Months | Opaque PET Cup with Clear Plastic | Shade “Red” + | Slight color loss in syrup |
| | Lid | Shade “Bordeaux | and in fruit pieces with |
| | | | some browning of syrup |
| | | | and fruit pieces. Color still |
| | | | acceptable. |
| 11 Months | Opaque PET Cup with Clear Plastic | Shade “Red” + | Slight color loss in syrup |
| | Lid | Shade “Bordeaux” | and in fruit pieces with |
| | | | some browning of syrup |
| | | | and fruit pieces. Color still |
| | | | acceptable. |
| 12 Months | Opaque PET Cup with Clear Plastic | Shade “Red” + | Slight color loss in syrup |
| | Lid | Shade “Bordeaux” | and in fruit pieces with |
| | | | some browning of syrup |
| | | | and fruit pieces. Color still |
| | | | acceptable. |
| 13 Months | Opaque PET Cup with Clear Plastic | Shade “Red” + | Slight color loss in syrup |
| | Lid | Shade “Bordeaux | and in fruit pieces with |
| | | | some browning of syrup |
| | | | and fruit pieces. Color still |
| | | | acceptable. |
| 14 Months | Opaque PET Cup with Clear Plastic | Shade “Red” + | Slight color loss in syrup |
| | Lid | Shade “Bordeaux | and in fruit pieces with |
| | | | some browning of syrup |
| | | | and fruit pieces. Color still |
| | | | acceptable. |
| 15 Months | Opaque PET Cup with Clear Plastic | Shade “Red” + | Slight color loss in syrup |
| | Lid | Shade “Bordeaux | and in fruit pieces with |
| | | | some browning of syrup |
| | | | and fruit pieces. Color still |
| | | | acceptable. |

EXBERRY® Shade “Red” and EXBERRY® Shade “Bordeaux” combined with “Superfruit, Pear Chunks in a blend of juices including Acai & Blackberry” exhibited significant color retention after 15 months of simulated exposure to normal retail environments. In both sample sets (1223-47-A, 1223-47-B), a slight change in color began after 9 months, with slight color loss and browning in the syrup and pear fruit pieces. The browning of the uncolored syrup and fruit pieces likely are the source of the color change.

While the invention has been described in conjunction with specific embodiments, it is evident that many alternatives, modifications, permutations, and variations will become apparent to those skilled in the art in light of the foregoing description. Accordingly, it is intended that the present invention embraces all such alternatives, modifications, and variations as falling within the scope of the claims below.

What is claimed is:

1. A method for producing a thermally stable purple color comprising:
combining a media with a food product, the media comprising at least one source of anthocyanins; and
maintaining the media at a pH value in the range of about pH 2 to about pH 6.

2. The method of claim 1 wherein the method comprises heating the media to a temperature of about 145° F. to about 280° F.

3. The method of claim 2 wherein the method comprises forming tin-anthocyanin complexes in the media.

4. The method of claim 3 wherein the media is exposed to tin by any one of a tin-lining in the container, a remanufactured food product, tin additives to the media, or media pre-treated by exposure to tin.

5. The method of claim 4 wherein tin is present in the media at about 1 ppm to about 60 ppm.

6. The method of claim 1 wherein the at least one source of anthocyanin comprises a plant, a flower, a fruit, or a vegetable.

7. The method of claim 1 wherein the at least one source of anthocyanin comprises a juice or a juice concentrate of a plant, a flower, a fruit, or a vegetable.

8. The method of claim 1 wherein the at least one source of anthocyanin comprises an anthocyanin supplement.

9. The method of claim 1 wherein the method comprises adding an anthocyanin supplement to the media to increase the anthocyanin concentration to about 50 ppm.

10. The method of claim 1 wherein the media is maintained at a pH value in the range of about 3.5 to about 4.

11. The method of claim 1 wherein the thermally stable purple color is also acid stable.

12. A method of preparing a heat resistant purple color for coloring acidified fruits and vegetables comprising:
combining a media comprising at least one form of anthocyanin capable of turning purple with a food product;
maintaining the media at a pH value in the range of about pH 2 to about pH 6; and
stabilizing the purple color by exposing the media to tin.

13. The method of claim 12 wherein the method comprises heating the media to about 145° F. to about 280° F.

14. The method of claim 12 wherein the media is exposed to tin by any one of tin-lining in the container, remanufactured food items, tin additives to the media, or pre-treating media with exposure to tin.

15. The method of claim 14 wherein tin is present in the media at about 1 ppm to about 60 ppm.

16. The method of claim 12 wherein the at least one source of anthocyanin comprises a plant, a flower, a fruit, or a vegetable.

17. The method of claim 12 wherein the at least one source of anthocyanin comprises a juice or a juice concentrate of a plant, a flower, a fruit, or a vegetable.

18. The method of claim 12 wherein the at least one source of anthocyanin comprises an anthocyanin supplement.

19. The method of claim 12 wherein the method comprises adding an anthocyanin supplement to the media to increase the anthocyanin concentration to about 50 ppm.

20. The method of claim 12 wherein the media is maintained at a pH value in the range of about 3.5 to about 4.

21. The method of claim 12 wherein the heat resistant purple color is acid stable.

22. A method for preparing a stable purple color at chilled to retort temperatures comprising:
combining a source of anthocyanins with media and a food product in a container; and
maintaining the media at a pH value in the range of about pH 2 to about pH 4.

23. The method of claim 22 wherein the method comprises heating the media to about 145° F. to about 280° F.

24. The method of claim 22 wherein the method comprises forming tin-anthocyanin complexes in the media.

25. The method of claim 24 wherein the media is exposed to tin by one of tin-lining in the container, remanufactured food items, tin additives to the media, or media pre-treated with tin or tin-exposure.

26. The method of claim 25 wherein tin is present in the media at about 1 ppm to about 60 ppm.

27. The method of claim 22 wherein the source of anthocyanins comprises a plant, a flower, a fruit, or a vegetable.

28. The method of claim 22 wherein the source of anthocyanins comprises a juice or a juice concentrate of a plant, a flower, a fruit, or a vegetable.

29. The method of claim 22 wherein the source of anthocyanin comprises an anthocyanin supplement.

30. The method of claim 22 wherein the method comprises adding an anthocyanin supplement to the media to increase the anthocyanin concentration to about 50 ppm.

31. The method of claim 22 wherein the purple color is acid stable.
